(19) United States
(12) Patent Application Publication
(10) Pub. No.: US 2009/0059476 A1
(43) Pub. Date: Mar. 5, 2009

(54) SOLID ELECTROLYTIC CAPACITOR AND METHOD FOR MANUFACTURING THE SAME

(75) Inventors: Masaaki Nemoto, Ota City (JP); Takashi Umemoto, Hirakata City (JP); Hiroshi Nonoue, Hirakata City (JP)

Correspondence Address: MOTS LAW, PLLC, 1629 K STREET N.W., SUITE 602, WASHINGTON, DC, 20006-1635, US

(73) Assignee: SANYO ELECTRIC CO., LTD., Moriguchi (JP)

(21) Appl. No.: 12/198,228

(22) Filed: Aug. 26, 2008

(30) Foreign Application Priority Data
Aug. 30, 2007 (JP) JP2007-224214

(51) Int. Cl. H01G 9/15; B05D 5/12

(52) U.S. Cl. 361/523; 427/80

(57) ABSTRACT

Solid electrolytic capacitors and methods for manufacturing the solid electrolytic capacitor are provided. The solid electrolytic capacitor has excellent reliability by virtue of stress reduction inside an electrolyte layer, which alleviates decrease in capacitance, increase of ESR and leakage current, and suppression of short circuits. The anode of the solid electrolytic capacitor is formed of a valve metal or an alloy thereof as a porous body. Subsequently, a dielectric layer is formed on a surface inside the porous body of the anode, and the electrolyte layer is formed on a surface of the dielectric layer. Here, the electrolyte layer is formed of a conductive polymer and the electrolyte layer inside the porous body of the anode contains an elastomer. Thereafter, a cathode is formed so as to come in contact with the electrolyte layer.

### CROSS REFERENCE TO RELATED APPLICATIONS

This application claims priority based on 35 USC 119 from prior Japanese Patent Application No. P2007-224214 filed on Aug. 30th, 2007, the entire contents of which are incorporated herein by reference.

### BACKGROUND OF THE INVENTION

1. Field of the Invention

The present invention relates to solid electrolytic capacitors including a dielectric layer and electrolyte layers on anode surfaces, and to a method for manufacturing solid electrolytic capacitors.

2. Description of Related Art

Because they have excellent high-frequency characteristics and are small in size with large capacities, solid electrolytic capacitors are used widely in high-frequency circuits of various kinds of electronic devices, such as personal computers, imaging devices, and the like.

A solid electrolytic capacitor is formed by a block-shaped anode body as a base. As the anode body, used is a sintered body of: a valve metal, such as tantalum, niobium, titanium, or aluminum; or an alloy thereof. A dielectric layer is formed on a surface of such sintered body by anodization or the like, and an electrolyte layer is formed on a surface of the dielectric layer. For the electrolyte layer, used is: a conductive inorganic material, such as a manganese dioxide; or a conductive organic material, such as a TCNQ complex salt or a conductive polymer.

A cathode lead layer is formed on the electrolyte layer. The cathode lead layer comprises, for example, a carbon layer and a silver layer. A cathode terminal is connected to such a cathode lead layer, whereas an anode terminal is connected to an anode lead member buried in the anode body. The anode terminal and the cathode terminal are connected in this manner, and thereafter the resultant body is sealed by an outer package made from an epoxy resin or the like.

A solid electrolytic capacitor disclosed in Japanese Patent Laid-open Publication No. Hei 8-33091 uses a conductive polymer layer as an electrolyte layer. In the solid electrolytic capacitor, a conductive polymer layer including a conductive polymer and a binder resin is formed on an outer surface of a capacitor element, and then a carbon layer and a silver layer are formed thereon. Thereby, if a crack or separation occurs in the conductive polymer layer, the carbon layer or the silver layer directly comes into contact with the dielectric layer to prevent an increase of leakage current.

However, if the electrolyte layer is formed of a conductive polymer, stress is generated inside the electrolyte layer from expansion and contraction of the conductive polymer layer when the electrolyte layer is exposed to a high temperature in a reflow process for the soldering and surface-mounting of the solid electrolytic capacitor. Consequently, there arise problems of decrease of capacitance, increase of an equivalent series resistance (ESR), and increase of leakage current.

### SUMMARY OF THE INVENTION

An aspect of the invention provides a solid electrolytic capacitor that comprises an anode, which is formed of a valve metal or an alloy thereof and which is a porous body; a dielectric layer on a surface inside the porous body of the anode; an electrolyte layer on a surface of the dielectric layer; and a cathode provided so as to come in contact with the electrolyte layer. The electrolyte layer is formed of a conductive polymer and an elastomer is contained in the electrolyte layer inside the porous body of the anode.

According to the above-described embodiment, the electrolyte layer is formed of a conductive polymer and an elastomer (elastic polymer) is contained in the electrolyte layer inside the porous body of the anode. Accordingly, stress generated inside the electrolyte layer can be reduced and capacitance decrease, ESR and leakage current increase, generation of electrical shorting, and the like, can be alleviated. Thus, the solid electrolytic capacitor with excellent reliability can be achieved.

The above-described elastomer includes a solid that uses a polymer substance as a resin material and has rubber-property elasticity at room temperature. Such elastomer includes at least one kind selected from the group consisting of a styrene-butadiene-based elastomer, polyolefin-based elastomer, urethane-based elastomer, polyester-based elastomer, polyamide-based elastomer, polyvinyl chloride-based elastomer, fluorinated thermoplastic elastomer, 1,2-polybutadiene, ionomer, silicone rubber, urethane rubber, and fluororubber.

The conductive polymer forming the above-described electrolyte layer is not particularly limited as long as a conductive polymer can form an electrolyte layer of a solid electrolytic capacitor. For example, the conductive polymer includes polypyrrole, polythiophene, polyaniline, and poly(3,4-ethylenedioxythiophene, and the like.

Preferably elastomer content in the electrolyte layer ranges from 1 volume % to 20 volume %. When the elastomer content is excessively large, ESR of the solid electrolytic capacitor can sometimes increase. In contrast, when the elastomer content is excessively small, effects of the present invention obtained by containing the elastomer cannot be obtained in some cases.

The above-described anode is formed of a porous body made from a valve metal or an alloy thereof. Such porous body can be obtained by sintering powder of a valve metal or an alloy thereof. The valve metal includes a metal, such as niobium, tantalum, titanium, aluminum, or the like. In addition, the alloy of the valve metal includes an alloy which mainly contains these valve metals. As the anode, an anode made of niobium or a niobium alloy is particularly preferably used.

Another aspect of the invention provides a method for manufacturing the solid electrolytic capacitor that comprises the steps of forming an anode which is formed of a valve metal or an alloy thereof and which is a porous body; forming a dielectric layer on a surface inside the porous body of the anode; forming an electrolyte layer on a surface of the dielectric layer; and forming a cathode so as to come in contact with the electrolyte layer. The electrolyte layer is formed of a conductive polymer and an elastomer is contained in the electrolyte layer inside the porous body of the anode.

As described above, the anode can be obtained by sintering powder of a valve metal or an alloy thereof. In addition, the dielectric layer can be formed, for example, by anodizing a surface of the anode. Since the anode is a porous body, a dielectric layer can be formed on the surface inside the porous body of the anode.

The electrolyte layer is formed of a conductive polymer. The conductive polymer layer can be formed by, for example, polymerizing monomers of the conductive polymer by a chemical polymerization method or an electrolytic polymerization method. If the conductive polymer layer is formed by the electrolytic polymerization method, it is preferable that a conductive polymer layer be formed in the following manner. A pre-coat layer formed of the conductive polymer is firstly formed by the chemical polymerization method, and then the pre-coat layer is brought into contact with an anode to carry out the electrolytic polymerization method.

The above-described electrolyte layer contains an elastomer. A representative for incorporating elastomer in the electrolyte layer is, for example, forming the electrolyte layer preferably by forming an elastomer by polymerization. For example, a method for polymerizing an elastomer may include at least one of a chemical polymerization method and an electrolytic polymerization method. If the process of forming an elastomer by polymerization is included in the method, such method can form the electrolyte layer. The process of forming the electrolyte layer includes the steps of: forming a first conductive polymer layer; forming an elastomer layer on the first conductive polymer layer; and forming a second conductive polymer layer on the elastomer layer. According to such a method, the electrolyte layer can contain an elastomer by provision of an elastomer layer between the first and second conductive polymer layers. In such a method, it is preferable that the first and second conductive polymer layers be electrically connected.

In addition, the step of forming the electrolyte layer may include the step of forming a conductive polymer layer that contains elastomer fine particles. Such method includes the formation of conductive polymer layer in the following manner. Elastomer fine particles are dispersed in a monomer solution of the conductive polymer and then monomers in the dispersion solution are polymerized. This method provides conductive polymer layer having dispersed elastomer fine particles.

The mean diameter size of the elastomer fine particle is preferably from 10 nm to 100 nm.

Since the elastomer is contained in the electrolyte layer, when the solid electrolytic capacitor is exposed to a high temperature in the reflow soldering process on the like, a stress generated inside the electrolyte layer can be reduced. In addition, decrease of capacitance, increase of ESR and leakage current, occurrence of a short circuit, and the like, can be prevented. Thus, a solid electrolytic capacitor with high reliability is obtained.

### BRIEF DESCRIPTION OF THE DRAWINGS

FIG. 1 is a schematic cross-sectional view showing a solid electrolytic capacitor of an embodiment.

FIG. 2 is a schematic cross-sectional view showing a state in pores inside a porous body of an anode of the solid electrolytic capacitor of an embodiment.

FIG. 3 is a schematic cross-sectional view showing a state in pores inside a porous body of an anode of a solid electrolytic capacitor of Comparative Example 1.

FIG. 4 is a schematic cross-sectional view showing a state in pores inside a porous body of an anode of a solid electrolytic capacitor of Comparative Example 2.

### DETAILED DESCRIPTION OF EMBODIMENTS

An embodiment of the invention will be described below based on the drawing. The drawing is only an embodiment, and the invention is not limited to proportions of sizes and the like in the drawing. Accordingly, specific sizes and the like have to be judged by considering the following description.

Prepositions, such as “on”, “over” and “above” may be defined with respect to a surface, for example a layer surface, regardless of that surface's orientation in space. The preposition “above” may be used in the specification and claims even if a layer is in contact with another layer. The preposition “on” may be used in the specification and claims when a layer is not in contact with another layer, for example, there is an intervening layer between them.

### First Embodiment

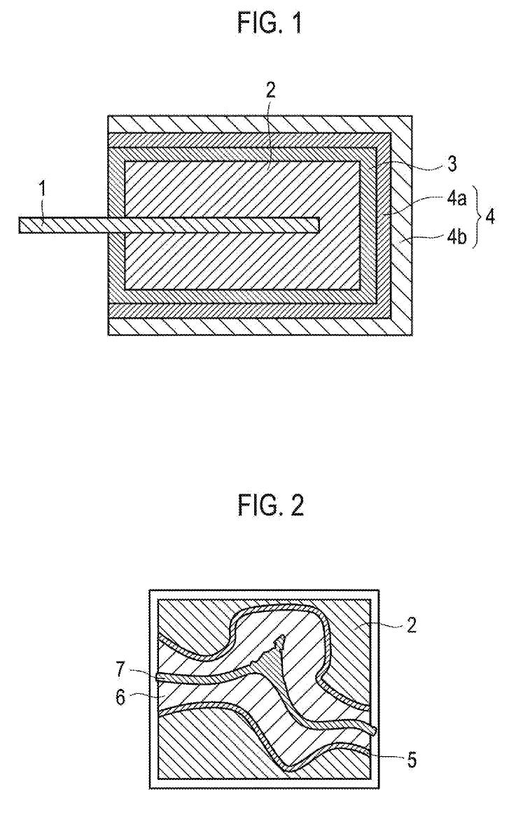

FIG. 1 is a schematic cross-sectional view showing a solid electrolytic capacitor of an embodiment. As shown in FIG. 1, anode lead member 1 is buried in the center of anode 2. In First Embodiment, anode 2 and anode lead member 1 are made of niobium. Anode 2 is formed by sintering niobium powder and is a porous body. Anode lead member 1 is manufactured by cutting a wire made of niobium to a predetermined length. In First Embodiment, anode 2 and anode lead member 1 are made of niobium, but may be made of another valve metal, such as tantalum, titanium, or aluminum, or an alloy.

A dielectric layer is formed on the surfaces of anode 2 and anode lead member 1. The dielectric layer is formed by anodizing the surfaces of anode 2 and anode lead member 1. For example, anode 2 and anode lead member 1 are soaked in a phosphoric acid solution and thereafter a voltage is applied to anode 2 and anode lead member 1 to anodize the surfaces of anode 2 and anode lead member 1.

FIG. 2 is a schematic cross-sectional view showing an inside of the porous body of anode 2. As shown in FIG. 2, dielectric layer 5 is formed on an inner surface of anode 2 as the porous body.

Subsequently, a pre-coat layer made of polypyrrole is formed on a surface of dielectric layer 5 by a chemical polymerization method. Specifically, an oxidant is applied onto anode 2 and anode lead member 1, and thereafter anode 2 and anode lead member 1 are soaked in a solution in which a monomer of polypyrrole is dissolved. A pre-coat layer is also formed by another method in which polypyrrole is left to stand in an atmosphere of this monomer so that polypyrrole is polymerized on dielectric layer 5. In anode lead member 1, the pre-coat layer may be formed only on a surface of a portion which is buried in anode 2. Accordingly, the pre-coat layer is not formed on the other portion of the dielectric layer of anode lead member 1. The other portion may be a protrusion from anode 2.

Thereafter, electrolytic polymerization is carried out to form a first conductive polymer layer on the pre-coat layer. In an emdbodiment, a layer including polypyrrole is formed as the first conductive polymer layer. Specifically, anode 2 and anode lead member 1 are first soaked in a solution into which the monomer of polypyrrole is dissolved. At this time, a level of a liquid surface of the solution is adjusted so that the portion of anode lead member 1 projecting from anode 2 would not be soaked therein. In a bath in which the solution containing the monomer is filled, an auxiliary electrode and an electrode plate are provided. Then, the electrolytic polymerization is carried out by applying a voltage using the auxiliary electrode as a positive electrode and the electrode plate as a negative electrode in a state where the auxiliary electrode is brought into contact with the pre-coat layer of anode 2. Note that the electrolytic polymerization is finished before pores anode 2 are completely filled with the conductive polymer in order to secure space for forming an elastomer layer. Timing of finishing the electrolytic polymerization can be determined by observing the state of filing of pores on the outer surface of anode 2 with the conductive polymer. Thereby, the electrolytic polymerization is finished before the pores on the outer surface of anode 2 are completely filled with the conductive polymer.

Next, the chemical polymerization is carried out for forming an elastomer layer. In this chemical polymerization, a catalyst is firstly impregnated into the surface of anode 2. Such methods for forming a catalyst include: a method in which processing is carried out by using TiCl₄ or the like after processing is carried out by using an organic magnesium compound such as Grignard reagent; and a method in which processing is carried out by using a titanium compound such as TiCl₄ after processing is carried out by using an organic magnesium such as Grignard reagent and then a reaction is caused with a halogenating agent and/or alcohols.

The elastomer layer is formed in the following manner. Firstly, the catalyst is applied on the surface of anode 2, that is, on the first conductive polymer layer in the inside of the porous body. Subsequently, anode 2 and anode lead member 1 are left to stand in an atmosphere of propylene and 1-hexene to polymerize propylene and 1-hexene so that the elastomer layer is formed. As conditions of polymerization, it is preferable that a temperature be equal to or less than a temperature at which a polymer is melted. More preferably, polymerization is carried out in a temperature range from 40° C. to 100° C. and a voltage range from normal pressure to 40 kg/cm² under a condition in which a monomer is not liquefied in the polymerization bath. In addition, in place of leaving propylene and 1-hexene in the atmosphere, propylene and 1-hexene may be polymerized in a state where in anode 2 and anode lead member 1 are soaked in a solution in which propylene and 1-hexene are dissolved. The elastomer formation method is not limited to the chemical polymerization method. The elastomer formation may be carried out by the electrolytic polymerization method or the like. In addition, in stead of 1-hexene, for example, α-olefin, whose number of carbons is 4 to 6, may be used.

After the elastomer layer is formed as described above, a second conductive polymer layer is formed thereon by the electrolytic polymerization method. The second conductive polymer layer can be formed by the electrolytic polymerization process similar to that of the first conductive polymer layer. The second conductive polymer layer is formed to fill pores in the porous body of anode 2. Thereafter, the second conductive polymer layer is further formed on the outer surface of anode 2. The resultant film serves as protective layer 3. Forming such protective layer 3 can prevent damage to the dielectric film.

Next, a burr portion formed on protective layer 3 is removed by irradiation with a laser beam.

As described above, the electrolyte layer according to First Embodiment is formed by sequentially forming the first conductive polymer layer, the elastomer layer, and the second conductive polymer layer. Electrolyte layer 6 according to First Embodiment includes elastomer layer 7 as shown in FIG. 2. The first conductive polymer layer is mainly formed inside the porous body of anode 2. Elastomer layer 7 is also formed inside the porous body. The second conductive polymer layer electrically comes in contact with the first conductive polymer layer and covers the outer surface of anode 2. Thereby, the covering functions as protective layer 3.

As shown in FIG. 1, carbon layer 4a is formed on protective layer 3. Carbon layer 4a can be formed by applying and then drying a carbon paste. Silver layer 4b is formed on carbon layer 4a. Silver layer 4b can be formed by applying and then drying a silver paste. Carbon layer 4a and silver layer 4b are included in cathode 4.

Next, a plate cathode terminal (unillustrated) is bonded to cathode 4 by using a conductive adhesive such as a silver paste. In addition, a plate anode terminal (unillustrated) is bonded to anode lead member 1 by spot welding or the like.

Subsequently, by using an epoxy resin, an outer package is molded by covering a circumference of anode 2 so that the anode terminal and the cathode terminal would be protruded to the outside thereof by a transfer mold method. As the epoxy resin, resin compositions, including a biphenyl-type epoxy resin and fire retardant (brominated epoxy resin/antimony trioxide), imidazole-based curing accelerator, flexibilizer (silicone), and filler (fused silica), are used. As the resin forming the outer package, a resin with small water absorption is preferably used as an outer body in order to inhibit moisture from going in and out, and to prevent cracks and separation at the time of reflow. Thereafter, the anode terminal and the cathode terminals are bent and further subjected to aging. Thereby, a solid electrolytic capacitor is completed.

### Second Embodiment

Second Embodiment is different from First Embodiment in terms of a process of forming an electrolyte layer. In Second Embodiment, a conductive polymer layer is first formed on a pre-coat layer by an electrolytic polymerization method. Thereafter, a fluid dispersion is prepared by dispersing fine particles (the mean particle diameter of 80 nm) of a copolymer of ethylene and 1-hexene in a solution in which pyrrole is dissolved so that a concentration of the solution would be 3 weight %. Here, the copolymer of ethylene and 1-hexene is a thermoplastic elastomer, and pyrrole is a monomer of the conductive polymer. Then, anode 2 is soaked in the fluid dispersion. It is preferable that the concentration of the fluid dispersion in which fine particles are dissolved be in a range from 1 weight % to 10 weight %. Similar to the electrolytic polymerization method carried out in First Embodiment, a conductive polymer layer in which elastomer fine particles are dissolved is formed by polymerizing pyrrole by the electrolytic polymerization method. The electrolytic polymerization method is carried out by applying a voltage by using an auxiliary electrode as a positive electrode and an electrode plate as a negative electrode in a state where the auxiliary electrode is brought into contact with a pre-coat layer in the liquid dispersion.

Subsequently, similar to First Embodiment, a second conductive polymer layer is formed to fill pores inside a porous body of an anode with the second conductive polymer. Thereafter, the second conductive polymer layer is formed on an outer surface of anode 2. The resultant film serves as protective layer 3. Then, similar to First Embodiment, a solid electrolytic capacitor is completed.

### Third Embodiment

Third Embodiment is different from First Embodiment in terms of a method for forming an elastomer. In Third Embodiment, similar to First Embodiment, a first conductive polymer layer is formed on a pre-coat layer. Thereafter, anode 2 is soaked in a solution obtained by mixing a base resin of 100 ml, a curative of 5 ml and thinner of 150 ml at room temperature. Here, the base resin contains a silicone resin cooled to be −25° C., the curative includes a polyisocyanate resin, and the thinner is mainly formed of toluene, xylene, and methanol. Then, anode 2 is placed in a refrigerator whose inside temperature is −25° C. and left to stand for 30 minutes.

Next, anode 2 is taken out from the solution and then is vacuum-impregnated in a vacuum of 100 mTorr at room temperature for one minute. Thereafter, anode 2 is reacted at 20° C. for one hour to form a silicone rubber and then is dried at 100° C. for 30 minutes. An elastomer layer made of a silicone rubber is formed on the first conductive polymer layer as described above.

Subsequently, similar to that of First Embodiment, a second conductive polymer layer is formed to fill pores inside a porous body of an anode with the second conductive polymer layer. Thereafter, the second conductive polymer layer is further formed on an outer surface of anode 2. The resultant film serves as protective layer 3. Thereafter, similar to First Embodiment, a solid electrolytic capacitor is completed.

As described above, a solid electrolytic capacitor with excellent reliability and a method for manufacturing the solid electrolytic capacitor can be provided. In the solid electrolytic capacitor, stress inside the electrolyte layer can be reduced. The problems of capacitance decrease, increase of ESR and leakage current, and occurrence of a short circuit can be prevented.

### Comparative Example 1

In Comparative Example 1, a solid electrolytic capacitor is manufactured in a similar manner to that of First Embodiment, except that an elastomer layer is not formed. That is to say, after a first conductive polymer layer is formed on a pre-coat layer, a second conductive polymer layer is subsequently formed on the first conductive polymer layer.

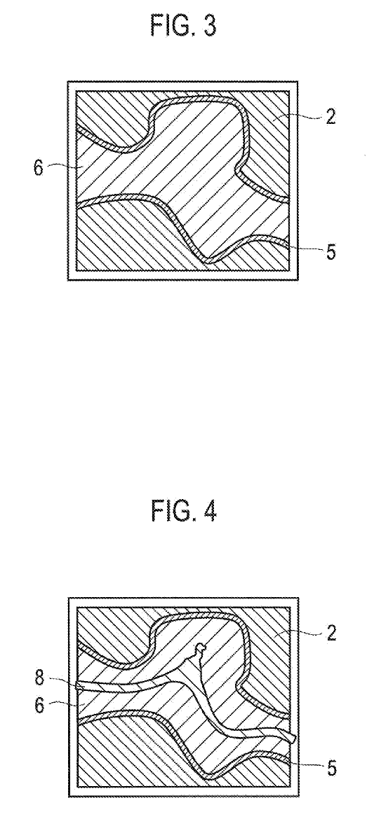

FIG. 3 is a schematic cross-sectional view showing an inside of a porous body of anode 2 according to Comparative Example 1. As shown in FIG. 3, electrolyte layer 6 formed of only a conductive polymer layer is formed in pores inside a porous body of anode 2.

### Comparative Example 2

In Comparative Example 2, an elastomer layer and a second conductive polymer layer are not formed. This means that carbon layer 4a and silver layer 4b are formed after a first conductive polymer layer is formed. Accordingly, in Comparative Example 2, protective layer 3 is not formed, either. Except as described above, a solid electrolytic capacitor is manufactured by a similar method to that of First Embodiment.

FIG. 4 is a schematic cross-sectional view showing an inside of a porous body of anode 2 according to Comparative Example 2. As shown in FIG. 4, void 8 is formed on electrolyte layer 6 which is formed of only a conductive polymer layer.

[Reflow Soldering and High-Temperature Loading Test]

Reflow soldering and high-temperature loading test are carried out on solid electrolytic capacitors manufactured in First to Third Embodiments and Comparative Example 1 and 2. The reflow soldering is carried out after heat treatment at 260° C. for 10 seconds. Thereafter, the high-temperature loading test is carried out at a temperature of 105° C. and an applied voltage of 2.5 V for the processing time of 1000 hours.

Rates of Changes in capacitance, ESR, and leakage current of each solid electrolytic capacitor are measured at an initial stage and after the reflow soldering and the high-temperature loading test. Tables 1 to 3 show results thereof. Note that measurement of capacitance is carried out at 120 Hz with an LCR meter. ESR measurement is carried out at 100 kHz with an LCR meter. Measurement of a leakage current is carried out with a direct current source and a current monitor. The number of measured samples is 100 in each of First to Third Embodments and Comparative Example 1 and 2. Note that a capacitor element that has been short-circuited when the manufacturing process is finished is excluded from evaluation targets from the initial stage and the subsequent stages.

TABLE 1

| | Capacitance change rate (%) | | |
|---|---|---|---|
| | | After | |
| | | reflow | After 1000 hour high |
| | Initial | soldering | temperature loading test |
| First Embodiment | 0.0 | −2.1 | −3.6 |
| Second Embodiment | 0.0 | −3.5 | −5.2 |
| Third Embodiment | 0.0 | −4.9 | −6.1 |
| Comparative Example 1 | 0.0 | −19.0 | −64.4 |
| Comparative Example 2 | 0.0 | −5.1 | −7.3 |

TABLE 2

| | ESR change rate (%) | | |
|---|---|---|---|
| | | After | |
| | | reflow | After 1000 hour high |
| | Initial | soldering | temperature loading test |
| First Embodiment | 0.0 | +8.4 | +10.6 |
| Second Embodiment | 0.0 | +7.5 | +9.8 |
| Third Embodiment | 0.0 | +9.1 | +11.7 |
| Comparative Example 1 | 0.0 | +188.3 | +692.0 |
| Comparative Example 2 | 0.0 | +23.0 | +39.4 |

TABLE 3

| | Leakage current change rate (%) | | |
|---|---|---|---|
| | | After | |
| | | reflow | After 1000 hour high |
| | Initial | soldering | temperature loading test |
| First Embodiment | 0.0 | +0.8 | −2.9 |
| Second Embodiment | 0.0 | +1.2 | −3.6 |
| Third Embodiment | 0.0 | +1.4 | −4.7 |
| Comparative Example 1 | 0.0 | +308.5 | +291.4 |
| Comparative Example 2 | 0.0 | +14.9 | +11.3 |

As apparent from the results shown in Tables 1 to 3, in First to Third Embodiments and Comparative Example 2, no considerable change in the change rates of capacitance, ESR, and leakage current is observed between after the reflow soldering and after the high temperature loading test. In contrast, in Comparative Example 1, considerable changes are observed in the change rates of capacitance, ESR, and leakage current. The reason is assumed as follows. In First to Third Embodiments, an elastomer is contained in the electrolyte layer and thus a moisture amount varies in the electrolyte layer to cause the electrolyte layer to expand and contract. That is to say, when a stress is generated inside the electrolyte layer, the stress inside the electrolyte layer can be reduced by the presence of the elastomer layer. Thereby, a separation of the electrolyte layer from the dielectric layer and cracks produced in the electrolyte layer and the dielectric layer are suppressed. In addition, in Comparative Example 2, it is assumed that a void is formed in the electrolyte layer, and the presence of this void reduces the stress inside the electrolyte layer. Thus, similar to that of First to Third Embodiments, the separation of the electrolyte layer from the dielectric layer and cracks produced in the electrolyte layer and the dielectric layer can be suppressed.

In contrast, in Comparative Example 1, a stress generated inside the electrolyte layer causes a separation of the electrolyte layer from the dielectric layer and cracks in the electrolyte layer and the dielectric layer. This is a possible cause of the increase in the change rate of capacitance, ESR, and leakage current become large.

Tables 4 and 5 show short-circuit rates and initial ESRs when manufacturing processes of First to Third Embodiments and Comparative Example 1 and 2 are finished.

TABLE 4

| | Shot-circuit rate (%) |
|---|---|
| First Embodiment | 0 |
| Second Embodiment | 0 |
| Third Embodiment | 0 |
| Comparative Example 1 | 0 |
| Comparative Example 2 | 21 |

TABLE 5

| | ESR (mΩ) |
|---|---|
| First Embodiment | 19.3 |
| Second Embodiment | 20.1 |
| Third Embodiment | 22.9 |
| Comparative Example 1 | 18.6 |
| Comparative Example 2 | 46.9 |

As shown in Tables 4 and 5, short-circuit rates of First to Third Embodiments are 0 %, whereas the short-circuit rate in Comparative Example 2 is 21%, a pretty large percentage. This is possibly because there is no protective layer in Comparative Example 2, and thus damages to the dielectric layer occur during the manufacturing processes. In addition, when compared with First to Third Embodiments, the initial ESR of Comparative Example 2 is larger. This is possibly because pores inside a porous body of an anode are not sufficiently filled with a conductive polymer.

As is clear from the foregoing results, in the solid electrolytic capacitors according to the examples, an elastomer is contained in the electrolyte layer so that stress inside the electrolyte layer can be reduced, and decrease of capacitance, increase of ESR and leakage current, occurrence of a short circuit can be prevented. Thereby, reliability of the solid electrolytic capacitor can be increased.

The invention includes other embodiments in addition to the above-described embodiments without departing from the spirit of the invention. The embodiments are to be considered in all respects as illustrative, and not restrictive. The scope of the invention is indicated by the appended claims rather than by the foregoing description. Hence, all configurations including the meaning and range within equivalent arrangements of the claims are intended to be embraced in the invention.

What is claimed is:

1. A solid electrolytic capacitor comprising:
an anode with a porous body formed from a valve metal or an alloy of a valve metal;
a dielectric layer on a surface inside the porous body of the anode;
an electrolyte layer on a surface of the dielectric layer, the electrolyte layer formed from a conductive polymer and comprising elastomers inside the porous body of the anode; and
a cathode in contact with the electrolyte layer.

2. The solid electrolytic capacitor of claim 1, wherein the elastomer is at least one kind selected from the group consisting of styrene-butadiene-based elastomers, polyolefin-based elastomers, urethane-based elastomers, polyester-based elastomers, polyamide-based elastomers, polyvinyl chloride-based elastomers, fluorinated thermoplastic elastomers, 1,2-polybutadiene, ionomers, silicone rubber, urethane rubber, and fluororubber.

3. The solid electrolytic capacitor of claim 1, wherein the valve metal or alloy thereof is at least one of niobium and a niobium alloy.

4. The solid electrolytic capacitor of claim 1, wherein the conductive polymer is at least one kind selected from the group consisting of polypyrrole, polythiophene, polyaniline, and poly(3, 4-ethylenedioxythiophene).

5. The solid electrolytic capacitor of claim 1, wherein the content of elastomer in the electrolyte layer is between 1 volume % and 20 volume % inclusive.

6. The solid electrolytic capacitor of claim 1, wherein the electrolyte layer comprises:
a conductive polymer layer on a surface of the dielectric layer; and
an elastomer layer on a surface of the conductive polymer layer.

7. The solid electrolytic capacitor of claim 6, wherein the electrolyte layer further comprises a second conductive polymer layer on a surface of the elastomer layer and on an outer surface of the anode.

8. A method for manufacturing a solid electrolytic capacitor, comprising:
forming an anode with a porous body formed from a valve metal or an alloy of a valve metal;
forming a dielectric film on a surface inside the porous body of the anode;
forming an electrolyte layer of a conductive polymer on a surface of the dielectric layer, the electrolyte layer comprising elastomers contained inside the porous body of the anode; and
forming a cathode in a manner that the cathode is in contact with the electrolyte layer.

9. The method of claim 8, comprising the step of forming an electrolyte layer by polymerization to make an elastomer.

10. The method of claim 8, wherein the electrolyte layer elastomer is formed by an electrolytic polymerization method.

11. The method of claim 8, wherein the electrolyte layer formation comprises:
forming a pre-coat layer of a conductive polymer on the surface of the dielectric layer by a chemical polymerization method; and
forming a conductive polymer layer on a surface of the pre-coat layer by an electrolytic polymerization method.

12. The method of claim 8, wherein the electrolyte layer formation comprises:
forming a first conductive polymer layer on the surface of the dielectric layer;
forming an elastomer layer on a surface of the first conductive polymer surface; and
forming a second conductive polymer layer on the elastomer layer.

13. The method of claim 8, wherein the electrolyte layer formation comprises forming a conductive polymer layer containing elastomer fine particles.

14. The method of claim 8, wherein the electrolyte layer formation comprises forming the conductive polymer layer in such a manner that the elastomer fine particles are dispersed in a monomer solution of a conductive polymer and then a monomer in the dispersion solution is polymerized.
